(19) United States
(12) Patent Application Publication
(10) Pub. No.: US 2018/0007328 A1
(43) Pub. Date: Jan. 4, 2018

(54) VIEWPOINT ADAPTIVE IMAGE PROJECTION SYSTEM

(71) Applicant: INTEL CORPORATION, SANTA CLARA, CA (US)

(72) Inventors: Mikko Kursula, Lempaala (FI); Tiina Hamalainen, Tampere (FI); Kalle I. Makinen, Nokia (FI); Lasse Lehonkoski, Tampere (FI); Marko Bonden, Tampere (FI)

(73) Assignee: INTEL CORPORATION, SANTA CLARA, CA (US)

(21) Appl. No.: 15/201,367

(22) Filed: Jul. 1, 2016

(51) Int. Cl. H04N 9/31; G06F 3/01

(52) U.S. Cl. CPC H04N 9/3185; G06F 3/013; H04N 9/3188

(57) ABSTRACT

Disclosed herein are systems and techniques to adapt an image to a gaze vector of a user or project content based on a distance between an appendage of a user and a at least a portion of a projected image. The system can include a projector to project an image and a camera to capture an image. The system can determine a gaze vector of a user and adapt the projected image based on the gaze vector. Additionally, the system can determine a distance between an appendage of the user and the projected image and project content based on the distance.

### TECHNICAL FIELD

Embodiments described herein generally relate to image projection systems. In particular, the present disclosure provides a viewpoint adaptive image projection system.

### BACKGROUND

Some computer systems project an image onto a surface to be viewed by a user adjacent to the surface. In many instances, the projection surface may not be perpendicular to the user's gaze, or viewpoint. As such, the projected image may not be perpendicular to the user's gaze. This can result in distortions of the image as viewed by the user. Furthermore, some systems that project images onto projection surfaces do not have conventional user interface controls, such as, for example, keyboards, mice, touch sensitive devices, or the like. As such, interaction with a user can be limited.

### BRIEF DESCRIPTION OF THE DRAWINGS

FIG. 1 illustrates an example first system.

FIG. 2 illustrates a first example gaze vector and adjusted projected image.

FIG. 3 illustrates a second example gaze vector and adjusted projected image.

FIG. 4 illustrates a third example gaze vector and adjusted projected image.

FIG. 5 illustrates a fourth example gaze vector and adjusted projected image.

FIG. 6 illustrates a first example logic flow.

FIG. 7 illustrates a second example logic flow.

FIG. 8 illustrates a third example logic flow.

FIG. 9 illustrates an example second system.

FIG. 10 illustrates an example scene.

FIG. 11 illustrates an example fourth logic flow.

FIG. 12 illustrates an example computer readable medium.

FIG. 13 illustrates an example system or device.

### DETAILED DESCRIPTION

Various embodiments may be an image projection system adaptive to a user's viewpoint. More particularly, an image projection system adaptable to a user's viewpoint is disclosed. The image projection system can include an image projector and a camera. The image projector may be configured to project light across a projection surface to display an image. Furthermore, the image projector can be configured to modify the projected light beams to adjust various parameters of the image. In particular, the image projector can modify the projected light beams to modify geometric parameters of the image to adjust the perspective of the image projected onto the projection surface. For example, the image projector can adjust geometric parameters of the image and/or the angle of incidence of the light beams onto the projection surface to adjust a perspective of the image projected onto the projection surface.

The camera can capture an image of an area adjacent to the projection surface. A user or a gaze vector corresponding to a user can be determined from the image. The projected image can be adjusted based on the gaze vector. More specifically, geometric properties of the image can be adjusted and the adjusted image projected onto the projection surface. As such, the image can be perceived in the correct perspective from the gaze vector. Said differently, the image can be “pre-distorted” based on the gaze vector and the pre-distorted image projected such that the image can be perceived undistorted from the gaze vector.

Additionally, a user can be identified from the image and a distance between the user and the projection surface can be determined. In some examples, an appendage of the user (e.g., arm, hand, finger(s), or the like) can be identified and a distance between the identified appendage and the projection surface determined. The system launch a user interface feature based on the determined distance. For example, the system can identify a user's hand from the image and determine whether the user's hand is less than a threshold distance from the projection surface. If it is determined that the identified hand is less than the threshold distance from the projection surface a user interface can be displayed on the projection surface. In some examples, the content display (or projected) on the projection surface can vary depending on the determined distance.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, known structures and devices are shown in block diagram form in order to facilitate a description thereof. The intention is to provide a thorough description such that all modifications, equivalents, and alternatives within the scope of the claims are sufficiently described.

Additionally, reference may be made to variables, such as, “a”, “b”, “c”, which are used to denote components where more than one component may be implemented. It is important to note, that there need not necessarily be multiple components and further, where multiple components are implemented, they need not be identical. Instead, use of variables to reference components in the figures is done for convenience and clarity of presentation.

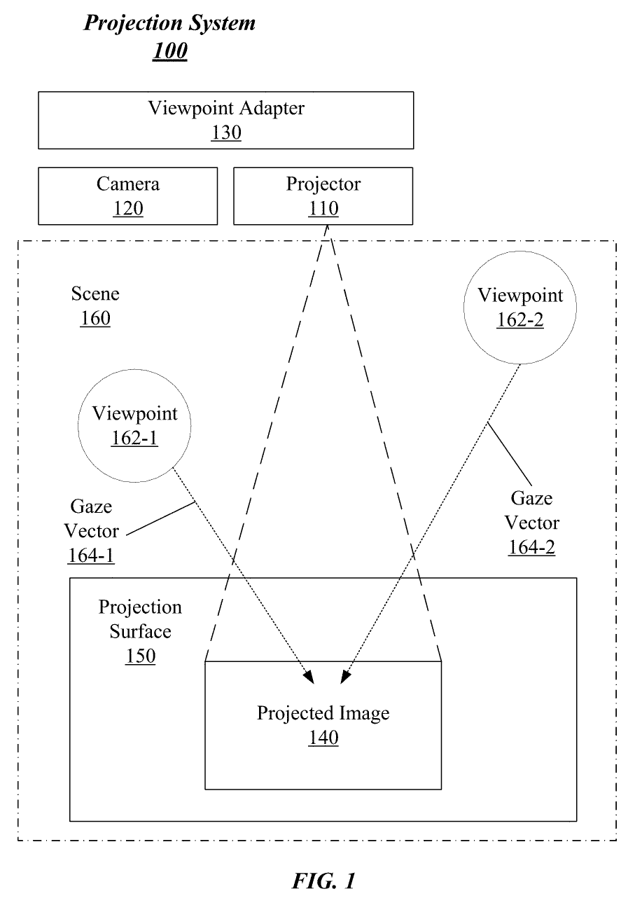

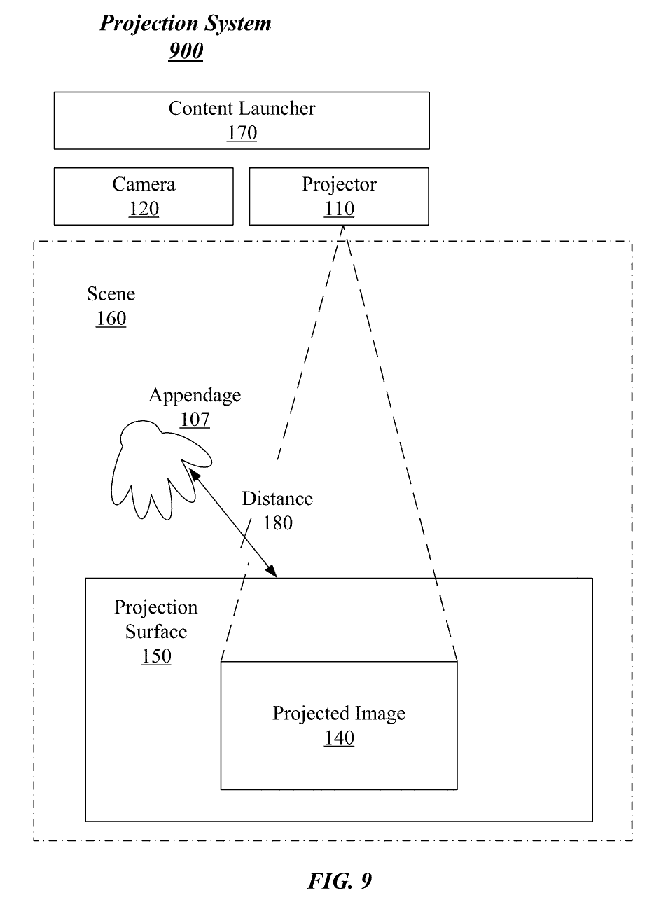

It is noted, that the present disclosure provides a system and techniques to adapt an image to a gaze vector of a user. The system and techniques can also project content and/or launch user interface features based on a distance between the user (or an appendage of the user) and the projection surface. A single system to both adapt the image to a gaze vector and provide user interface display can be provided. However, for purposes of clarity of presentation, separate systems are described. In particular, FIG. 1 depicts a system to adapt an image to a gaze vector while FIG. 9 depicts a system to display user interface content based on a distance between an appendage of the user and the projection surface. Examples, however, are not limited in this context.

Turning more specifically to FIG. 1, which illustrates a block diagram of a projection system 100 to adapt to a viewpoint. In general, the system 100 is configured to determine a gaze vector, adjust an image to be projected, and project the adjusted image to adapt to a viewpoint corresponding to the gaze vector. Said differently, the system 100 can determine a viewpoint, for example, of a user, and a gaze vector corresponding to the viewpoint. An image can be adjusted based on the gaze vector. For example, the image can have geometric parameters adjusted to form a pre-distorted image, or the like. The adjusted image can be projected onto a projection surface. As such, the user may perceive the image in a correct perspective from the gaze vector. Determination of a gaze vector is described in greater detail below. However, in general, the gaze vector may be determined based on identifying a user in the image and identifying facial features of the user. For example, a user's eyes, nose, mouth, ears, pupils, or the like can be identified and triangulated with respect to points on the projection surface to determine a gaze vector.

The system 100 comprises a projector 110, a camera 120, and a viewpoint adapter 130. In general, the projector 110 can be any of a variety of projectors to project an image onto a projection surface. For example, the projector 110 can project light beams through a lens to project the image onto a projection surface. As another example, the projector 110 can project the image directly, for example, using laser and/or mirrors, or the like. For example, without limitation, the projector 110 can be a cathode ray tube (CRT) projector, a liquid crystal display (LCD) projector, a digital light processing (DLP) projector, a liquid crystal on silicon (LCoS) projector, a light emitting diode (LED) projector, a laser diode projector, or a micro-electrical-mechanical system (MEMS) based projector. Examples are not limited in this context.

In general, the camera 120 can be any of a variety of cameras to capture an image. In particular, in some examples, the camera 120 can be a wide angle camera. More specifically, the camera 120 can be a wide angle three-dimensional (3D) camera system to capture an image of a user adjacent to a projection surface. For example, the camera 120 can configured to capture multiple two-dimensional (2D) images such that a distance between points on the projection surface and a user captured in the 2D images can be determined. This is sometimes referred to as a range camera. In another example, the camera 120 can be a stereo camera, or more specifically, a camera to capture multiple images via multiple lens operating in tandem. In another example, the camera 120 can be a 3D scanner system to capture images of the projection surface and adjacent area to determine the gaze vector. It is noted, that the camera 120 can implement any of a variety of digital image capture technology. For example, the camera 120 can implement a charge-coupled device (CCD) image sensor, a complementary metal-oxide-semiconductor (CMOS) image sensor, or the like.

In general, the viewpoint adapter 130 can be logic, which can be implemented as hardware, to determine a gaze vector, to adjust properties of an image to be projected based on the gaze vector, and to send the adjusted image to the projector to be projected onto the projection surface. For example, the viewpoint adapter 130 can be a processor programmed to implement the features described. As another example, the viewpoint adapter 130 can be a general purpose computer including a processor, memory, a graphics processing unit, and communication interfaces programmed to implement the features described. Examples are not limited in this context.

During operation, the projector 110 can project an image 140 onto a projection surface 150. In some examples, the projector 110 can project the image onto different portions of the projection surface 150. In general, the projector 110 can receive control signals and/or information elements to include indications of image data (e.g., pixels, or the like) to project onto the projection surface 150. For example, the projector 110 can receive control signals and/or information elements from the viewpoint adapter 130.

During operation, the camera 120 can capture an image of a scene 160. These scene 160 can include an area adjacent to a projection surface 150 and can also include the projection surface 150. In some examples, the camera 120 may repeatedly (e.g., on a set schedule, based on user interaction, upon changing of the projected image 140, or the like) capture an image of the scene 160. In some examples, the camera 120 may capture multiple images of the scene 160 (e.g., from different angles, different lenses, different cameras, different image sensors, or the like) to provide a 3D perspective view of objects (e.g., users, or the like) and their positional relationship to the projection surface 150 and/or the projected image 140.

The viewpoint adapter 130 can identify a user or users of the system 100. Said differently, the viewpoint adapter 130 can identify viewer(s) of the projection surface 150 and/or the projected image 140 from the scene 160. The users can have a particular viewpoint 162 proximate to the projection surface. For example, a first user having viewpoint 162-1 is depicted in scene 160 along with a second user having view point 162-2. It is noted, that multiple users are depicted in the scene 160 for purposes of explanation only. However, the system 100 can identify a single user from the scene 160. As another example, the viewpoint adapter 130 can identify a user having a first viewpoint (e.g., the viewpoint 162-1) and subsequently (e.g., due to movement of the user, or the like) identify the user having a second viewpoint (e.g., the viewpoint 162-2). Examples are not limited in this context.

Additionally, the viewpoint adapter 130 can determine a gaze vector or gaze vectors corresponding to the viewpoints 162. For example, gaze vectors 164-1 and 164-2 are depicted. It is noted, that the gaze vectors 164-1 and 164-2 are depicted in two-dimension. However, it is to be appreciated, that the gaze vectors 164-1 and 164-2 could be three-dimensional. More specifically, the gaze vectors 164-1 and 164-2 correspond to a vector between the viewpoints 162-1 and 162-2, respectively, and the projected image. In some examples, the gaze vectors 164-1 and 164-2 could correspond to a vector between the viewpoints 162-1 and 162-2 and the center of the projected image, the center of the projection surface, a specific point on the projection surface, or the like. Examples are not limited in this context.

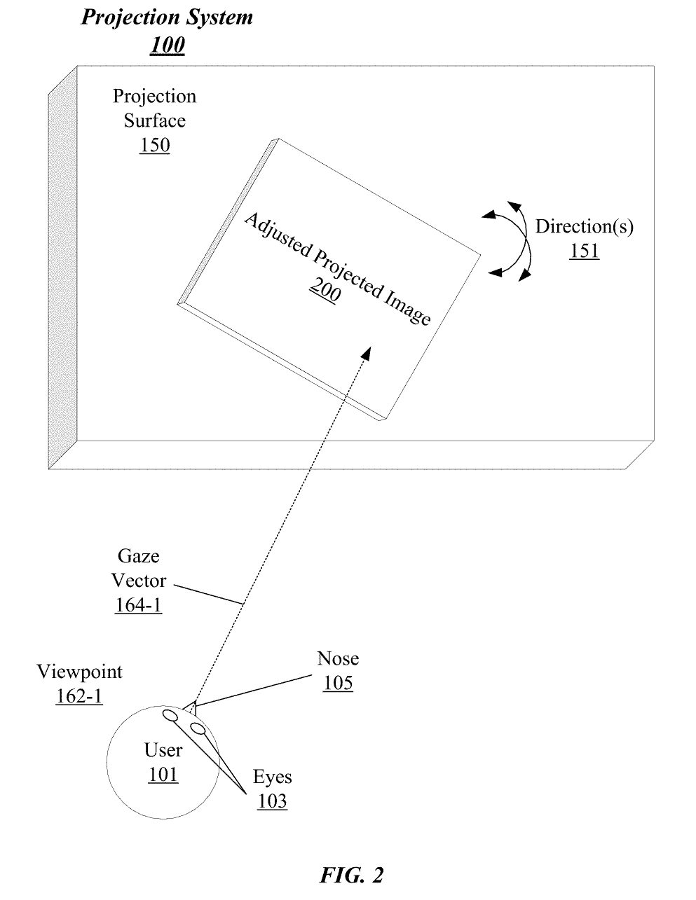

Additionally, the viewpoint adapter 130 can adjust parameter(s) of the projected image 140. For example, the viewpoint adapter 130 can adjust geometric properties of the projected image 140, resulting in a pre-distorted image, or the like. The viewpoint adapter 130 can send control signals and/or information elements to the projector 110 to cause the projector 110 to project the adjusted image, resulting in adjusted projected images being projected onto the projection surface 150 (e.g., refer to example adjusted projected images in FIGS. 2-5).

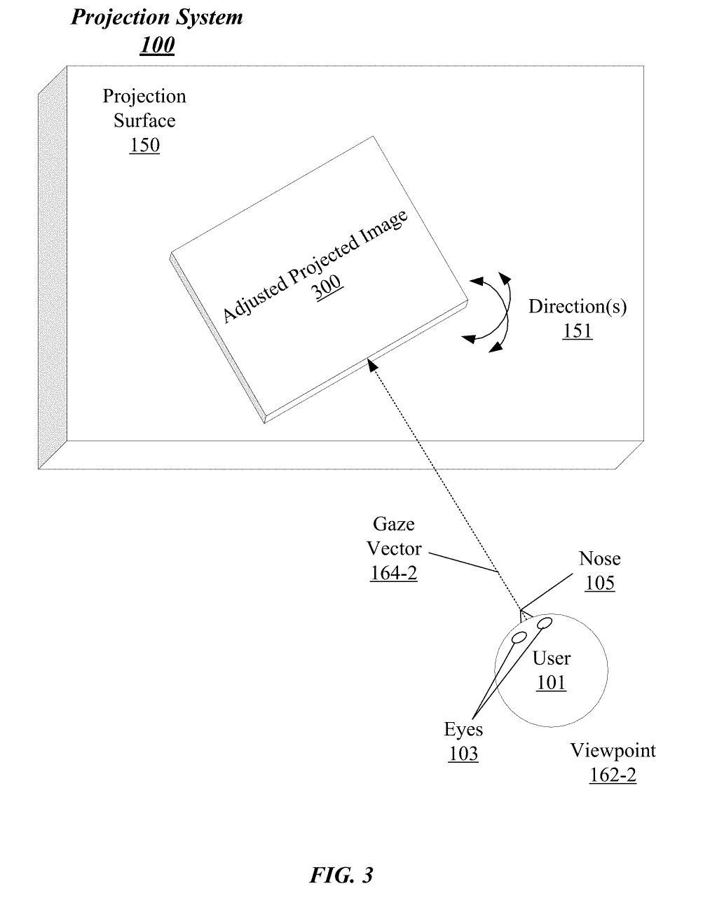

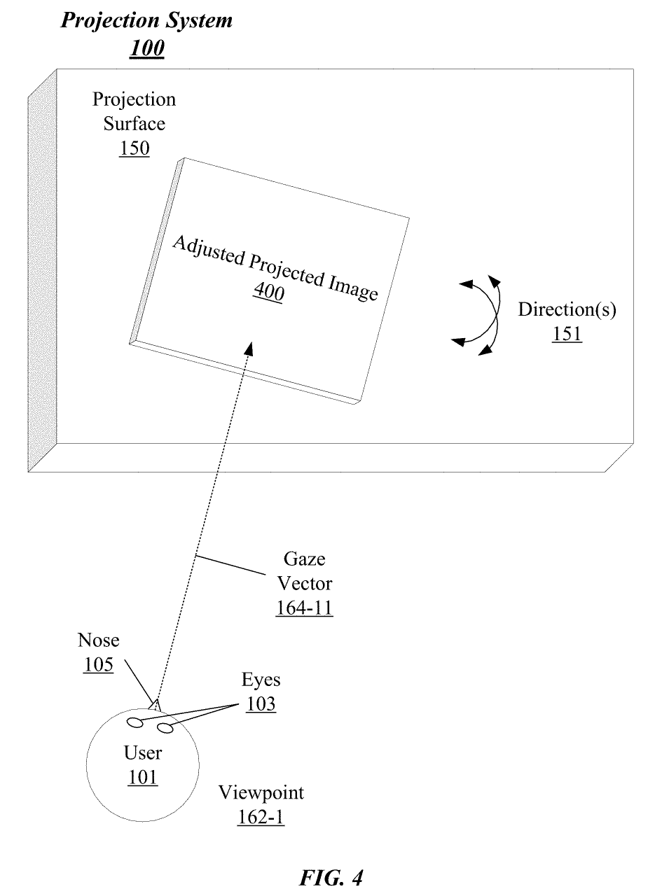

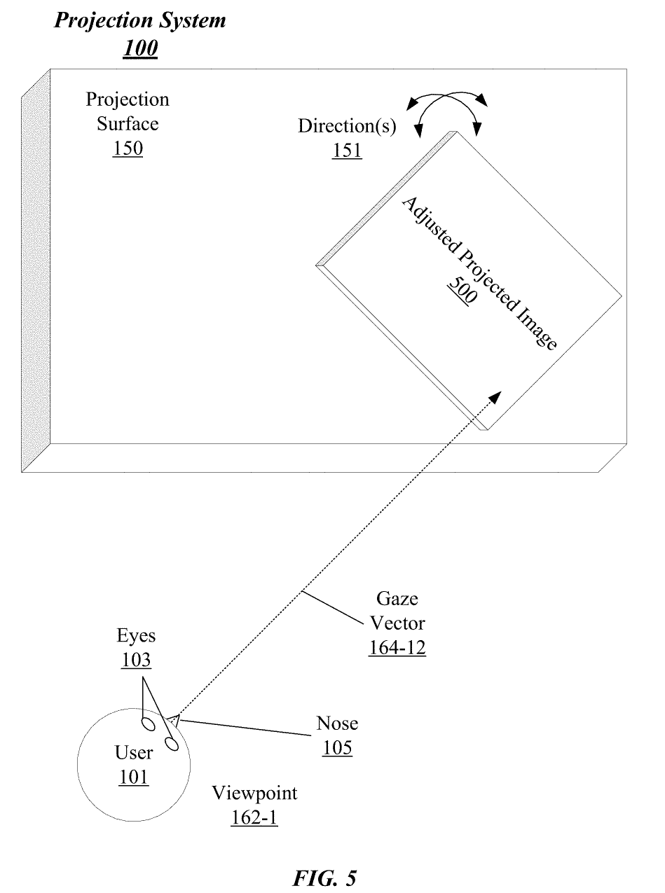

FIGS. 2-5 depict perspective views of the projection surface, an example user 101, and an example adjusted projected images corresponding to different gaze vectors determined based on identification of the user in an image of the scene. In particular, FIG. 2 depicts the projection surface 150 and an adjusted projected image 200 corresponding to the gaze vector 164-1 while FIG. 3 depicts the projection surface 150 and an adjusted projected image 300 corresponding to the gaze vector 164-2. It is noted, that FIGS. 2-3 depict adjusted projected images 200 and 300 corresponding to different viewpoints (e.g., examples where a user moves positions, or the like). FIG. 4 depicts the projection surface 150 and an adjusted projected image 400 corresponding to the gaze vector 164-11 while FIG. 5 depicts the projection surface 150 and an adjusted projected image 500 corresponding to the gaze vector 164-12. It is noted, that FIGS. 4-5 depict adjusted projected images 400 and 500 corresponding to different gaze vectors from the same viewpoint (e.g., examples where a user changes position of his/her head, or the like). It is to be appreciated, that the example adjusted projected images and gaze vectors depicted herein are given for purposes of illustration only and not to be limiting.

Turning more specifically to FIG. 2, the user 101 is depicted. The user 101 can be identified from image(s) of the scene 160. For example, the viewpoint adapter 130 can implement various person and/or facial recognition techniques to identify the user 101 from the image(s) of the scene 160. Viewpoint 162-1 corresponding to the position of the user 101 can be determined. For example, viewpoint adapter 130 can implement geometric and/or geographic pinpoint technologies to determine viewpoint 162-1 based on the location of the identified user 101 and the projection surface 150 in the scene 160.

Additionally, gaze vector 164-1 can be determined. For example, the viewpoint adapter 130 can implemented various facial recognition techniques and correlate the identified facial features to a location on the projection surface to determine a vector corresponding to the angle in which the user 101 views the projected image 140. For example, the viewpoint adapter 130 can identify the eyes 103 and nose 105 of the user 101 and determine the gaze vector 164-1 based on the position of the eyes 103 and nose 105 in relation to the projection surface 150.

Additionally, the projected image 140 can be adjusted, resulting in adjusted projected image 200. The adjusted projected image 200 can be projected onto projection surface 150. As such, the user 101 may perceive the adjusted projected image 200 in a correct perspective and/or aspect when viewing the projection surface 150 from the gaze vector 164-1. In particular, the viewpoint adapter 130 can adjust parameters of the projected image 140 to pre-distort the projected image 140. For example, the viewpoint adapter 130 can skew the projected image 140 in a direction (e.g., direction(s) 151, or the like). The viewpoint adapter 130 can rotate the projected image 140 in a direction (e.g., direction(s) 151, or the like). The viewpoint adapter 130 can enlarge areas and/or shrink areas of the projected image 140. Said differently, the viewpoint adapter 130 can adjust geometric properties of the projected image 140. In particular, the viewpoint adapter can generate the adjusted projected image 200 based on adjusting one or more properties of the projected image.

Turning more specifically to FIG. 3, the user 101 is depicted. However, it is to be appreciated, the position of the user 101 is this figure is different than the position of the user 101 as identified in the scene depicted in FIG. 2. As before, the user 101 can be identified from image(s) of the scene 160. For example, the viewpoint adapter 130 can implement various person and/or facial recognition techniques to identify the user 101 from the image(s) of the scene 160. Viewpoint 162-2 corresponding to the position of the user 101 can be determined. For example, viewpoint adapter 130 can implement geometric and/or geographic pinpoint technologies to determine viewpoint 162-2 based on the location of the identified user 101 and the projection surface 150 in the scene 160.

In some implementations, the scene 160 can include an environment adjacent to the projection surface and the projection surface. For example, the scene 160 is depicted including the projection surface 150 and areas (e.g., an environment) adjacent to the projection surface 150. The viewpoint adapter 130 can identify the projection surface 150 from the image of the scene 160. More particular, the viewpoint adapter 130 can implement object recognition techniques to identify the projection surface 150 from the scene 160. Additionally, the viewpoint adapter 130 can identify the projected image 140 from the image of the scene 160. More specifically, the viewpoint adapter 130 can implement object recognition techniques to identify the projected image 140, or said differently, the image projected onto the projection surface 150.

The system 100 can further determine the gaze vector 164-2. For example, the viewpoint adapter 130 can implemented various facial recognition techniques and correlate the identified facial features to a location on the projection surface to determine a vector corresponding to the angle in which the user 101 views the projected image 140. For example, the viewpoint adapter 130 can identify the eyes 103 and nose 105 of the user 101 and determine the gaze vector 164-2 based on the position of the eyes 103 and nose 105 in relation to the projection surface 150.

Additionally, the projected image 140 can be adjusted, resulting in adjusted projected image 300. The adjusted projected image 300 can be projected onto projection surface 150. As such, the user 101 may perceive the adjusted projected image 300 in a correct perspective and/or aspect when viewing the projection surface 150 from the gaze vector 164-2. In particular, the viewpoint adapter 130 can adjust parameters of the projected image 140 to pre-distort the projected image 140. For example, the viewpoint adapter 130 can skew the projected image 140 in a direction (e.g., direction(s) 151, or the like). The viewpoint adapter 130 can rotate the projected image 140 in a direction (e.g., direction(s) 151, or the like). The viewpoint adapter 130 can enlarge areas and/or shrink areas of the projected image 140. Said differently, the viewpoint adapter 130 can adjust geometric properties of the projected image 140. In particular, the viewpoint adapter can generate the adjusted projected image 300 based on adjusting one or more properties of the projected image.

Turning more specifically to FIG. 4, the user 101 is depicted. As before, the user 101 can be identified from image(s) of the scene 160. For example, the viewpoint adapter 130 can implement various person and/or facial recognition techniques to identify the user 101 from the image(s) of the scene 160. Viewpoint 162-1 corresponding to the position of the user 101 can be determined. For example, viewpoint adapter 130 can implement geometric and/or geographic pinpoint technologies to determine viewpoint 162-1 based on the location of the identified user 101 and the projection surface 150 in the scene 160.

Additionally, gaze vector 164-11 can be determined. It is noted, that a user (e.g., the user 101) can have multiple gaze vectors (e.g., refer to both FIGS. 4-5) corresponding to a single viewpoint (e.g., the viewpoint). For example, the viewpoint adapter 130 can implemented various facial recognition techniques and correlate the identified facial features to a location on the projection surface to determine a vector corresponding to the angle in which the user 101 views the projected image 140. For example, the viewpoint adapter 130 can identify the eyes 103 and nose 105 of the user 101 and determine the gaze vector 164-11 based on the position of the eyes 103 and nose 105 in relation to the projection surface 150.

Additionally, the projected image 140 can be adjusted, resulting in adjusted projected image 400. The adjusted projected image 400 can be projected onto projection surface 150. As such, the user 101 may perceive the adjusted projected image 400 in a correct perspective and/or aspect when viewing the projection surface 150 from the gaze vector 164-11. In particular, the viewpoint adapter 130 can adjust parameters of the projected image 140 to pre-distort the projected image 140. For example, the viewpoint adapter 130 can skew the projected image 140 in a direction (e.g., direction(s) 151, or the like). The viewpoint adapter 130 can rotate the projected image 140 in a direction (e.g., direction(s) 151, or the like). The viewpoint adapter 130 can enlarge areas and/or shrink areas of the projected image 140. Said differently, the viewpoint adapter 130 can adjust geometric properties of the projected image 140. In particular, the viewpoint adapter can generate the adjusted projected image 400 based on adjusting one or more properties of the projected image.

Turning more specifically to FIG. 5, the user 101 is depicted. However, it is to be appreciated, the gaze vector of the user 101 in this figure is different than the gaze vector of the user 101 as identified in the scene depicted in FIG. 4, despite the users having the same viewpoint. As before, the user 101 can be identified from image(s) of the scene 160. For example, the viewpoint adapter 130 can implement various person and/or facial recognition techniques to identify the user 101 from the image(s) of the scene 160. Viewpoint 162-1 corresponding to the position of the user 101 can be determined. For example, viewpoint adapter 130 can implement geometric and/or geographic pinpoint technologies to determine viewpoint 162-1 based on the location of the identified user 101 and the projection surface 150 in the scene 160.

Additionally, gaze vector 164-12 can be determined. It is noted, that a user (e.g., the user 101) can have multiple gaze vectors (e.g., refer to both FIGS. 4-5) corresponding to a single viewpoint (e.g., the viewpoint). For example, the viewpoint adapter 130 can implemented various facial recognition techniques and correlate the identified facial features to a location on the projection surface to determine a vector corresponding to the angle in which the user 101 views the projected image 140. For example, the viewpoint adapter 130 can identify the eyes 103 and nose 105 of the user 101 and determine the gaze vector 164-12 based on the position of the eyes 103 and nose 105 in relation to the projection surface 150.

Additionally, the projected image 140 can be adjusted, resulting in adjusted projected image 500. The adjusted projected image 500 can be projected onto projection surface 150. As such, the user 101 may perceive the adjusted projected image 500 in a correct perspective and/or aspect when viewing the projection surface 150 from the gaze vector 164-12. In particular, the viewpoint adapter 130 can adjust parameters of the projected image 140 to pre-distort the projected image 140. For example, the viewpoint adapter 130 can skew the projected image 140 in a direction (e.g., direction(s) 151, or the like). The viewpoint adapter 130 can rotate the projected image 140 in a direction (e.g., direction(s) 151, or the like). The viewpoint adapter 130 can enlarge areas and/or shrink areas of the projected image 140. Said differently, the viewpoint adapter 130 can adjust geometric properties of the projected image 140. In particular, the viewpoint adapter can generate the adjusted projected image 400 based on adjusting one or more properties of the projected image.

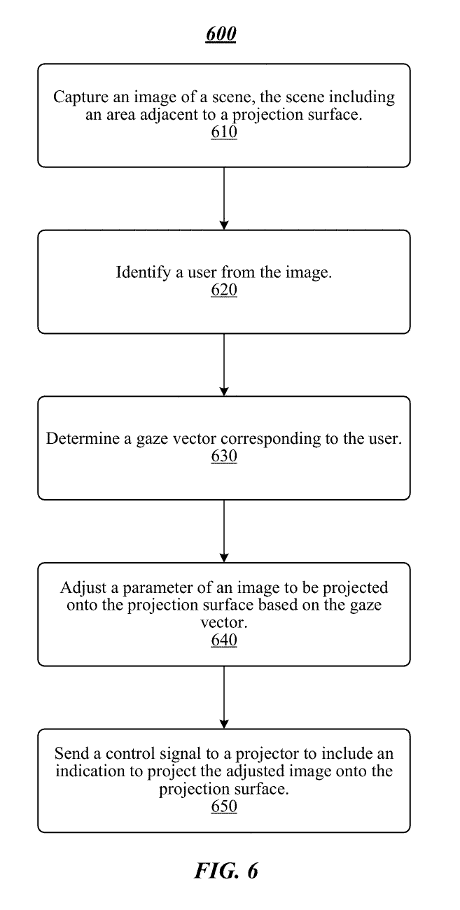

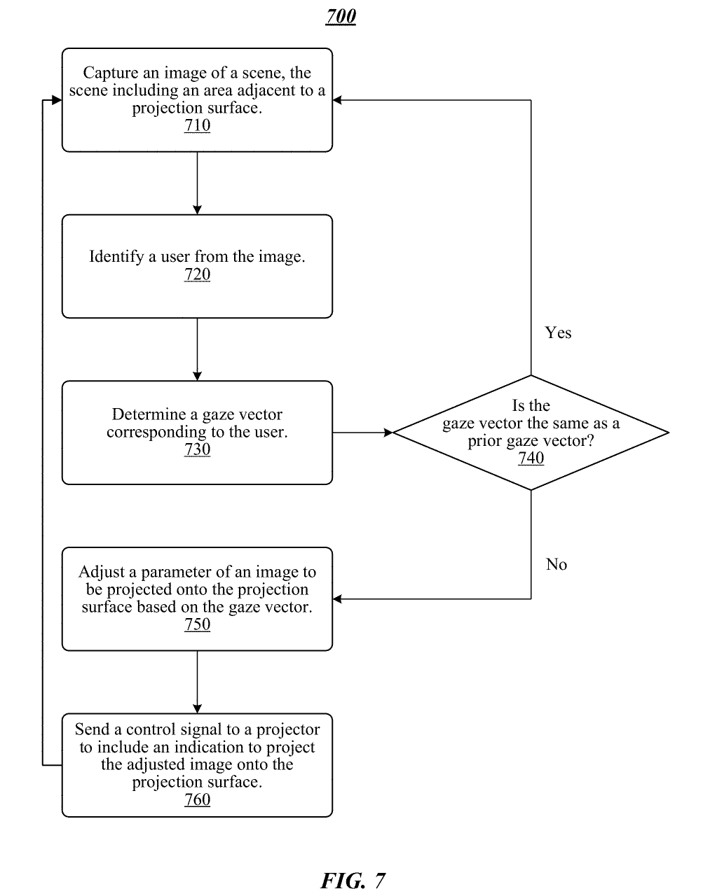

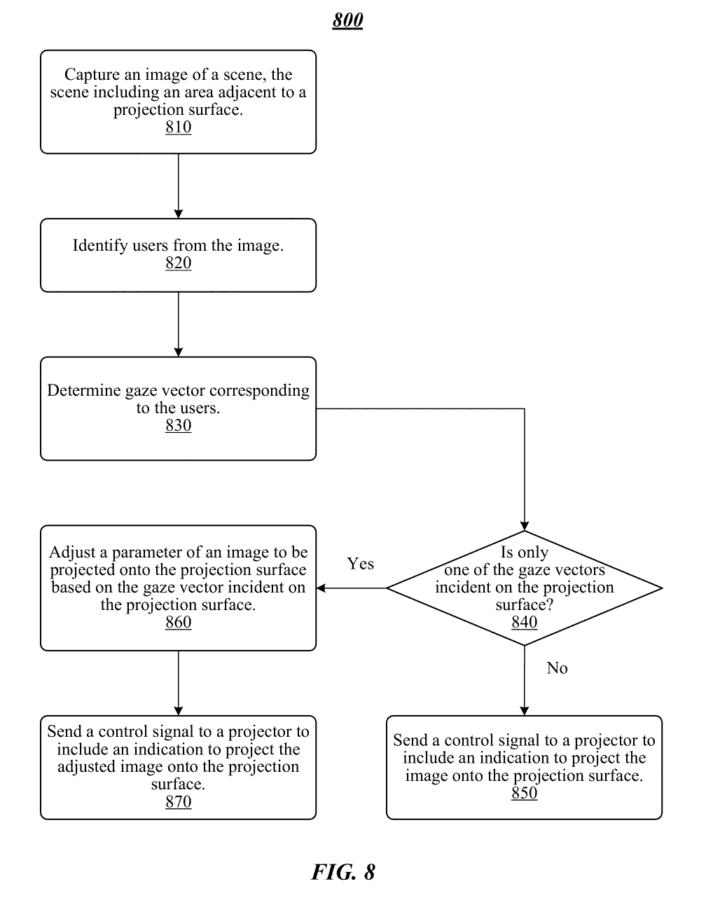

FIGS. 6-8 illustrate logic flows to adapt a projected image to a viewpoint. In particular, FIG. 6 illustrates a logic flow 600 to adapt an image to a viewpoint, while FIG. 7 illustrates a logic flow 700 to repeatedly adapt an image to a viewpoint, and FIG. 8 illustrates a logic flow 800 to adapt an image to a viewpoint based on detecting multiple users in a scene. In some examples, the logic flows 600, 700, and/or 800 can be implemented to adapt a projected image to a viewpoint and/or a gaze vector. It is noted, the logic flows 600, 700 and 800 are described with reference to the projection system 100 depicted in FIG. 1 for purposes of illustration only and not to be limiting. It is to be appreciated, however, that the logic flows 600, 700 and/or 800 could be implemented to adapt a projected image to a viewpoint and/or gaze vector using an alternative projection system to the system 100. Examples are not limited in this context.

Turning more specifically to FIG. 6, the logic flow 600 may begin at block 610. At block 610 “capture an image of a scene, the scene including an area adjacent to a projection surface” an image of a scene can be captured. In particular, an image of a scene including an environment adjacent to a projection surface can be captured. For example, the camera 120 can capture an image of the scene 160. In some examples, the scene includes the projection surface 150. In some examples, the scene includes an environment adjacent to the projection surface 150.

Continuing to block 620 “identify a user from the image” a user can be identified from the image. For example, the viewpoint adapter 130 can implement object and/or person recognition techniques to identify a user (e.g., the user 101, or the like) from the image of the scene 160. Additionally, the viewpoint adapter 130 can identify the projection surface 150 from the image of the scene 160. In some examples, the viewpoint adapter 130 can identify the projected image 140 from the image of the scene 160.

Continuing to block 630 “determine a gaze vector corresponding to the user” a gaze vector corresponding to the user identified at block 620 can be determined. More particularly, a gaze vector corresponding to a direction(s) in which the user is gazing can be determined. For example, the viewpoint adapter 130 can implement facial recognition techniques to identify a number of facial features (e.g., eyes 103, nose 105, or the like) of the user 101. The viewpoint adapter 130 can determine a vector corresponding to the gaze of the user 101 based on the identified facial features. The gaze vector 164 can be the vector identified based on the facial features. It is noted, that other facial features (e.g., chin, ears, forehead, mouth, or the like) can be identified and used to determine the gaze vector. Examples are not limited in this context.

Continuing to block 640 “adjust a parameter of an image to be projected onto the projection surface based on the gaze vector” a parameter of an image to be projected onto the projection surface can be adjusted. For example, a parameter of the projected image 140 can be adjusted based on the gaze vector. In some examples, the viewpoint adapter 130 can adjust a number of parameters of the projected image to, in essence, pre-distort the projected image such that the adjusted projected image is perceived from the gaze vector undistorted. For example, the viewpoint adapter 130 can adjust a geometric property of the image (e.g., skew, angle, rotation, size, proportion, or the like) to distort the projected image based on the gaze vector.

Continuing to block 650 “send a control signal to a projector to include an indication to project the adjusted image onto the projection surface” a control signal including an indication to project the adjusted projected image onto the projection surface can be sent to a projector. For example, the viewpoint adapter can send a control signal to the projector 110 to include an indication to project the adjusted projected image (e.g., adjusted projected image 200, adjusted projected image 300, adjusted projected image 400, adjusted projected image 500, or the like) onto the projection surface.

Turning more specifically to FIG. 7, the logic flow 700 may begin at block 710. At block 710 “capture an image of a scene, the scene including an area adjacent to a projection surface” an image of a scene can be captured. In particular, an image of a scene including an environment adjacent to a projection surface can be captured. For example, the camera 120 can capture an image of the scene 160. In some examples, the scene includes the projection surface 150. In some examples, the scene includes an environment adjacent to the projection surface 150.

Continuing to block 720 “identify a user from the image” a user can be identified from the image. For example, the viewpoint adapter 130 can implement object and/or person recognition techniques to identify a user (e.g., the user 101, or the like) from the image of the scene 160. Additionally, the viewpoint adapter 130 can identify the projection surface 150 from the image of the scene 160. In some examples, the viewpoint adapter 130 can identify the projected image 140 from the image of the scene 160.

Continuing to block 730 “determine a gaze vector corresponding to the user” a gaze vector corresponding to the user identified at block 720 can be determined. More particularly, a gaze vector corresponding to a direction(s) in which the user is gazing can be determined. For example, the viewpoint adapter 130 can implement facial recognition techniques to identify a number of facial features (e.g., eyes 103, nose 105, or the like) of the user 101. The viewpoint adapter 130 can determine a vector corresponding to the gaze of the user 101 based on the identified facial features. The gaze vector 164 can be the vector identified based on the facial features. It is noted, that other facial features (e.g., chin, ears, forehead, mouth, or the like) can be identified and used to determine the gaze vector. Examples are not limited in this context.

Continuing to decision block 740 “is the gaze vector the same as a prior gaze vector” a determination of whether the gaze vector determined at block 730 is the same a prior gaze vector can be determined. For example, the viewpoint adapter 130 can compare the vector determined at block 730 with a vector corresponding to the image currently projected into the projection surface. From decision block 740, the logic flow 700 can continue to either block 750 or return to block 710. In particular, the logic flow 700 can return to block 710 based on a determination that the gaze vectors are the same while the logic flow 700 can continue to block 750 based on a determination that the gaze vectors are not the same. Upon returning to block 710, the camera can capture another image of the scene 160, and the logic flow 700 may continue as described.

At block 750 “adjust a parameter of an image to be projected onto the projection surface based on the gaze vector” a parameter of an image to be projected onto the projection surface can be adjusted. For example, a parameter of the projected image 140 can be adjusted based on the gaze vector. In some examples, the viewpoint adapter 130 can adjust a number of parameters of the projected image to, in essence, pre-distort the projected image such that the adjusted projected image is perceived from the gaze vector undistorted. For example, the viewpoint adapter 130 can adjust a geometric property of the image (e.g., skew, angle, rotation, size, proportion, or the like) to distort the projected image based on the gaze vector.

Continuing to block 760 “send a control signal to a projector to include an indication to project the adjusted image onto the projection surface” a control signal including an indication to project the adjusted projected image onto the projection surface can be sent to a projector. For example, the viewpoint adapter can send a control signal to the projector 110 to include an indication to project the adjusted projected image (e.g., adjusted projected image 200, adjusted projected image 300, adjusted projected image 400, adjusted projected image 500, or the like) onto the projection surface.

Turning more specifically to FIG. 8, the logic flow 800 may begin at block 810. At block 810 “capture an image of a scene, the scene including an area adjacent to a projection surface” an image of a scene can be captured. In particular, an image of a scene including an environment adjacent to a projection surface can be captured. For example, the camera 120 can capture an image of the scene 160. In some examples, the scene includes the projection surface 150. In some examples, the scene includes an environment adjacent to the projection surface 150.

Continuing to block 820 “identify users from the image” users can be identified from the image. For example, the viewpoint adapter 130 can implement object and/or person recognition techniques to identify a number of users (e.g., users at different viewpoints, or the like) from the image of the scene 160. Additionally, the viewpoint adapter 130 can identify the projection surface 150 from the image of the scene 160. In some examples, the viewpoint adapter 130 can identify the projected image 140 from the image of the scene 160.

Continuing to block 830 “determine a gaze vector corresponding to the user” gaze vectors corresponding to each of the users identified at block 820 can be determined. More particularly, gaze vectors corresponding to direction(s) in which the users are gazing can be determined. For example, the viewpoint adapter 130 can implement facial recognition techniques to identify a number of facial features (e.g., eyes 103, nose 105, or the like) of each the users. The viewpoint adapter 130 can determine vectors corresponding to the gaze of the users based on the identified facial features. The gaze vectors 164 can be the vectors identified based on the facial features. It is noted, that other facial features (e.g., chin, ears, forehead, mouth, or the like) can be identified and used to determine the gaze vector. Examples are not limited in this context.

Continuing to decision block 840 “is only one of the gaze vectors incident on the projection surface” a determination of whether only one of the gaze vectors is incident on the projection surface can be determined. For example, the viewpoint adapter 130 can determine whether ones of the gaze vectors 164 are incident on the projection surface 150. From decision block 840, the logic flow 800 can continue to either block 850 or block 860. In particular, the logic flow 800 can continue to block 850 based on a determination that more than one gaze vector is incident on the projection surface while the logic flow 800 can continue to block 860 based on a determination that only one of the gaze vectors is incident on the projection surface.

At block 850 “send a control signal to a projector to include an indication to project the image onto the projection surface” a control signal including an indication to project the image, for example, in an unadjusted form, onto the projection surface can be sent to a projector. For example, the viewpoint adapter 130 can send a control signal to the projector 110 to include an indication to project the projected image 140 onto the projection surface 150.

At block 860 “adjust a parameter of an image to be projected onto the projection surface based on the gaze vector” a parameter of an image to be projected onto the projection surface can be adjusted. For example, a parameter of the projected image 140 can be adjusted based on the gaze vector incident on the projection surface 150. In some examples, the viewpoint adapter 130 can adjust a number of parameters of the projected image to, in essence, pre-distort the projected image such that the adjusted projected image is perceived from the gaze vector undistorted. For example, the viewpoint adapter 130 can adjust a geometric property of the image (e.g., skew, angle, rotation, size, proportion, or the like) to distort the projected image based on the gaze vector incident on the projection surface.

Continuing to block 870 “send a control signal to a projector to include an indication to project the adjusted image onto the projection surface” a control signal including an indication to project the adjusted projected image onto the projection surface can be sent to a projector. For example, the viewpoint adapter can send a control signal to the projector 110 to include an indication to project the adjusted projected image (e.g., adjusted projected image 200, adjusted projected image 300, adjusted projected image 400, adjusted projected image 500, or the like) onto the projection surface.

Turning more specifically to FIG. 9, which illustrates a block diagram of a projection system 900 to project context based on a user's proximity to the projection surface. In general, the system 900 may include components similar to the system 100 described previously. Furthermore, as noted, a system could be provided that includes components and is configured to both systems 100 and 900. Examples are not limited in this context.

In general, the system 900 is configured to project content based on a determined distance between a projection surface and the user. More specifically, the system 900 can identify an appendage of a user from an image of an environment including a projection surface and can determine a distance between the identified appendage and the projection surface. The system can project content onto the projection surface based on the determined distance. In some examples, the content can be user interface content (e.g., menus, information dialogues, or the like). In some examples, different content can be displayed based on the determined distance. In some examples, different content can be displayed based on the identified appendage.

The system 900 comprises the projector 110, the camera 120, and a content launcher 170. In general, the content launcher can be logic, which can be implemented in hardware, to send a control signal to the projector to cause the projector to project content onto the projection surface based on a determined distance between a user's appendage and the projection surface. For example, the content launcher 170 can be a processor programmed to implement the features described. As another example, the content launcher 170 can be a general purpose computer including a processor, memory, a graphics processing unit, and communication interfaces programmed to implement the features described. Examples are not limited in this context.

During operation, the projector 110 can project an image 140 onto a projection surface 150. In some examples, the projector 110 can project the image onto different portions of the projection surface 150. In general, the projector 110 can receive control signals and/or information elements to include indications of image data (e.g., pixels, or the like) to project onto the projection surface 150. For example, the projector 110 can receive control signals and/or information elements from the content launcher 170.

During operation, the camera 120 can capture an image of a scene 160. These scene 160 can include an area adjacent to a projection surface 150 and can also include the projection surface 150. In some examples, the camera 120 may repeatedly (e.g., on a set schedule, based on user interaction, upon changing of the projected image 140, or the like) capture an image of the scene 160. In some examples, the camera 120 may capture multiple images of the scene 160 (e.g., from different angles, different lenses, different cameras, different image sensors, or the like) to provide a 3D perspective view of objects (e.g., users, or the like) and their positional relationship to the projection surface 150 and/or the projected image 140.

The content launcher 170 can identify an appendage (e.g. of a user of the system 900, or the like). Said differently, the content launcher 170 can identify appendages (e.g., a hand, hands, a finger, fingers, an arrangement of fingers, or the like) from the scene 160. For example, hand 107 is depicted in scene 160. Additionally, the content launcher 170 can determine a distance 180 between the identified appendage (e.g., hand 107) and the projection surface 150. In some examples, the content launcher 170 can determine the distance 180 as between the identified appendage and the projected image or as between the identified appendage and a portion of the projected image.

The content launcher 170 can send a control signal to the projector 110 to cause the projector 110 to display an image or “content” based on the determined distance. In some examples, the content launcher 170 can send a control signal to the projector 110 to cause the projector 110 to display particular content based on the determined distance 180, the type or arrangement of the appendage 107, and/or a portion of the projected image to which the appendage is proximate.

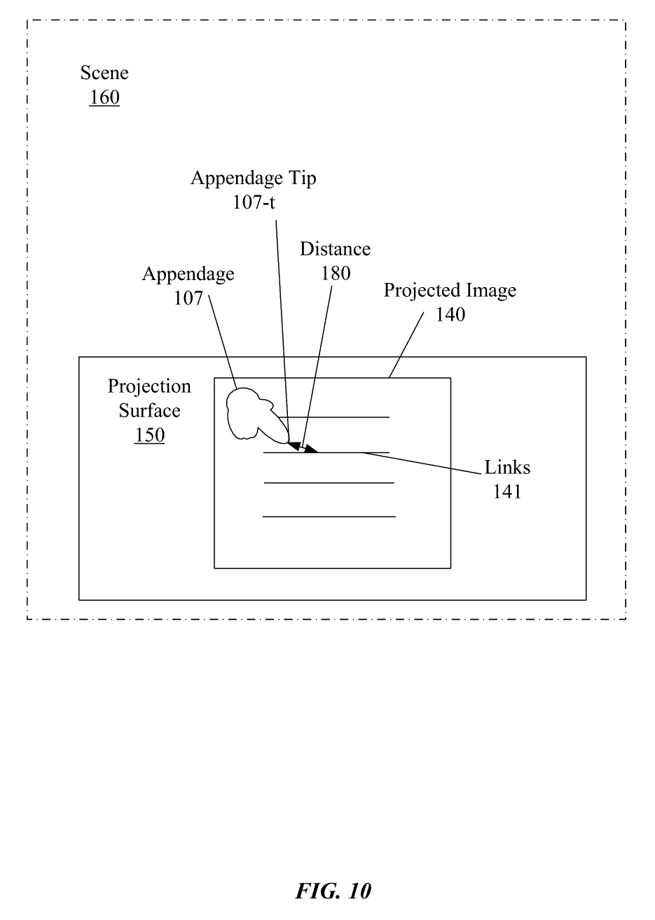

FIG. 10 illustrates an example scene 160 depicting an appendage proximate to a portion of the projected image. The example scene in this figure is given for purposes of discussion and is described with respect to the system 900 of FIG. 9. During operation, the camera 120 can capture an image of the scene 160. The content launcher 170 can identify the appendage 107 from the scene 160. As a specific example, the content launcher 170 can identify the hand 107. In some examples, the content launcher 170 can identify the appendage 107 in a specific arrangement (e.g. with the index finger extended as depicted, or the like). In some examples, the content launcher 170 can identify a portion of the appendage (e.g., fingertip 107-t, or the like). The content launcher can determine the distance 180 between the identified appendage and a portion of the projected image 140. For example, the content launcher 170 can determine the distance 180 as between the identified fingertip 107-t and a link 141 of the projected image 140. It is noted, the projected image 140 can have any manner of content, and the links 141 are depicted for purpose of clarity of presentation. As an alternative example, the content launcher 170 could determine the distance as between the appendage 107 and an image in the projected image 140, a region of the projected image 140, a user interface element (e.g., button, key, or the like) of the projected image 140.

The content launcher 170 can send a control signal to the projector 110 to cause the projector to project content based on the determined distance. In some examples, the content launcher 170 can send a control signal to include an indication of the content to be displayed. In some examples, the content to be displayed can be determined based on the identified appendage, the distance 180, or the portion of the projected image (e.g., link 141, or the like). For example, the content launcher 170 can send a control signal to the projector to cause the projector to project content corresponding to the link 141.

In some examples, the content launcher 170 can be configured to determine various gestures. For example, the content launcher 170 can determine a hovering gesture based on a distance between the identified appendage and the display surface (e.g., distance between 180 greater than a threshold level (e.g., 1 cm to 5 cm from projected image, or the like)). As an example, the content launcher 170 could send a control signal to the projector 120 to cause the projector 120 to magnify the projected image 140 or to display content in a pop-up on the projected image 140 based on the detected hovering. In some examples, the projected image 140 could correspond to an input device (e.g., keyboard, touchpad, or the like) and the content launcher 170 can determine input (e.g., keypresses, touch input, or the like) based on the determined distance 180 and location on the projected image 140 in which the identified appendage is proximate. In some examples, the content launcher 170 can detect a swiping gesture and can send a control signal to the projector 110 to modify or augment (e.g., scroll, move, or the like) the projected image 140 accordingly. In some examples, the content launcher 170 can detect a hand gesture (e.g., rotation, or the like) and can send a control signal to the projector 110 modify or augment (e.g., rotate, or the like) the projected image 140 accordingly. In some examples, the content launcher 170 can detect a hand signal (e.g., “ok” sign, crossed fingers, or the like) and can send a control signal to the projector 110 to project content accordingly. For example, a hand signal can be detected and a user interface (e.g., menu, window, or the like) projected based on the detected hand signal.

In some examples, the content launcher 170 can determine the distance 180 based on image analysis. In some examples, the projector 110 and the camera 120 can be configured to project light signals and receive light signals to determine the distance. For example, the camera 120 can be configured to detect infrared light and can determine the distance 180 based on the detected infrared light (e.g., as reflected from the projector surface 150 versus the appendage 107, or the like). In some examples, the projector 120 can be configured to interleave a distance measurement signal (e.g., projected light) with the light corresponding to the projected image 140. For example, distance measurement light signals could be interleaved in the time domain with the projected image 140 light signals. In some examples, the projector 120 can be configured to project a distance measurement light pattern. For example, the projector 120 can project a distance measurement light patterns in sequence with projecting light patterns corresponding to the projected image. More specifically, the projector 120 could be a field sequential type projector and can project a sequence of red, green, and blue light patterns. The projector 120 could be configured to project a sequence of red, green, blue, and distance measurement light patterns.

The content launcher 170 can determine the distance based on signals received by the camera 120 corresponding to the projected light patterns and/or distance measurement light signals.

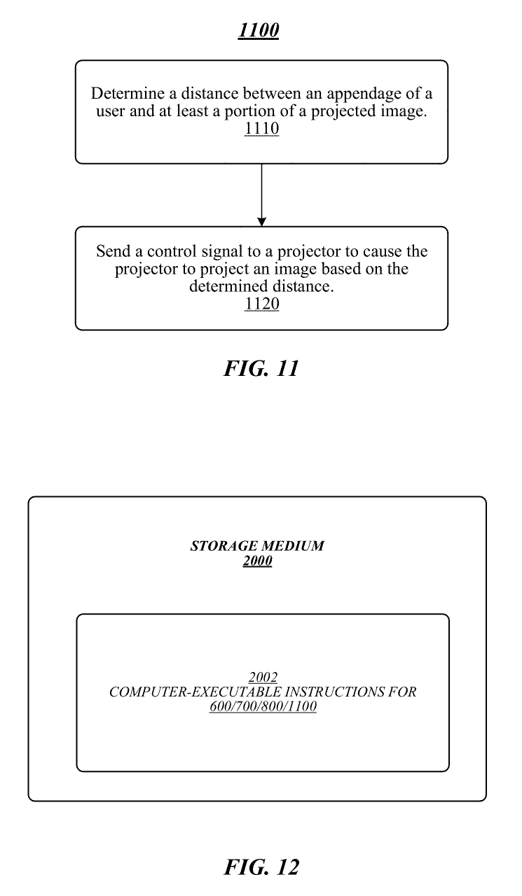

FIG. 11 illustrates a logic flow 1100 to project content based on a distance between an appendage of a user and a projected image. It is noted, the logic flow 1100 is described with reference to the projection system 900 depicted in FIG. 9 for purposes of illustration only and not to be limiting. It is to be appreciated, however, that the logic flow 1100 could be implemented to project content based on a determined distance between a user's appendage and a projected image using an alternative projection system to the system 900. Examples are not limited in this context.

The logic flow 1100 may begin at block 1110. At block 1110 “determine a distance between an appendage of a user and at least a portion of a projected image” a distance between an appendage and a projected image, or a portion of the projected image can be determined. In particular, an appendage can be determined (e.g., from a scene, or the like) and a distance between the appendage and a portion of a projected image determined. For example, the content launcher can identify appendage 107 and determine distance 180 from an image of scene 160, from distance measurement light signals projected through scene 160, or the like.

Continuing to block 1120 “send a control signal to a projector to cause the projector to project an image based on the determined distance” an image can be projected based on the determined distance. For example, a control signal can be sent to a projector to cause the projector to display content based on a determined distance being less than a threshold value. In some examples, the displayed content can be based on a portion of the projected image to which the distance is measured. For example, the content launcher 170 can send a control signal to the projector 110 to cause the projector 110 to project content based on the determined distance 180, based on the identified appendage 107, and/or based on a portion of the projected image 140 to which the distance 180 is measured (e.g., link 141, or the like).

FIG. 12 illustrates an embodiment of a storage medium 2000. The storage medium 2000 may comprise an article of manufacture. In some examples, the storage medium 2000 may include any non-transitory computer readable medium or machine readable medium, such as an optical, magnetic or semiconductor storage. The storage medium 2000 may store various types of computer executable instructions e.g., 2002). For example, the storage medium 2000 may store various types of computer executable instructions to implement technique 600. For example, the storage medium 2000 may store various types of computer executable instructions to implement logic flow 700. For example, the storage medium 2000 may store various types of computer executable instructions to implement logic flow 800. For example, the storage medium 2000 may store various types of computer executable instructions to implement logic flow 1100.

Examples of a computer readable or machine readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like. The examples are not limited in this context.

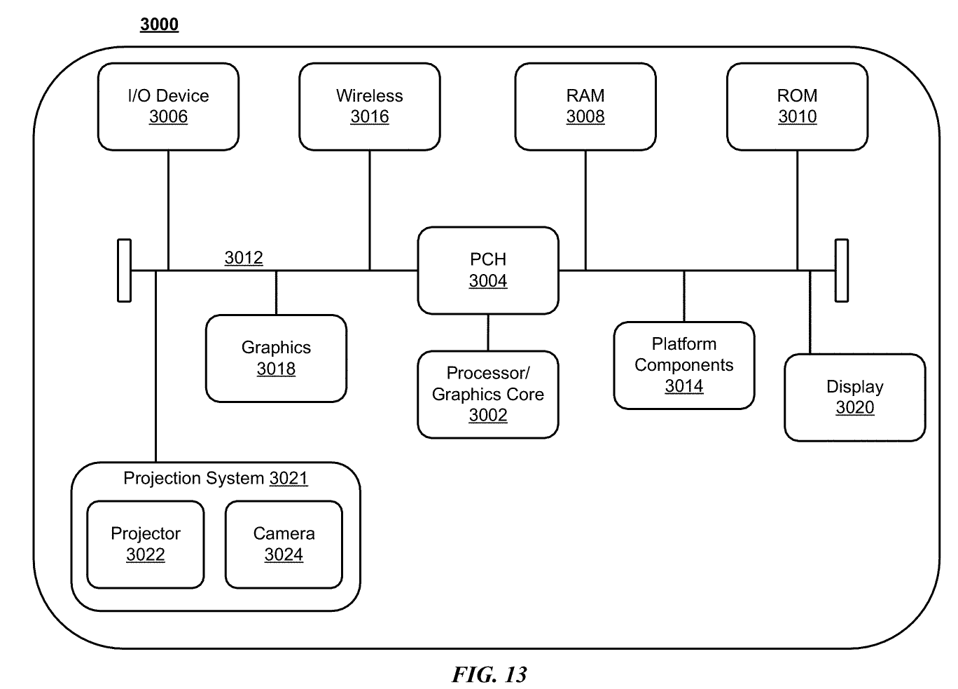

FIG. 13 is a diagram of an exemplary system embodiment and in particular, depicts a platform 3000, which may include various elements. For instance, this figure depicts that platform (system) 3000 may include a processor/graphics core 3002, a chipset/platform control hub (PCH) 3004, an input/output (I/O) device 3006, a random access memory (RAM) (such as dynamic RAM (DRAM)) 3008, and a read only memory (ROM) 3010, display 3020 (e.g., projection surface 150, or the like), projection system 3021 (e.g., projector 110, or the like), and various other platform components 3014 (e.g., a fan, a cross flow blower, a heat sink, DTM system, cooling system, housing, vents, and so forth). System 3000 may also include wireless communications chip 3016 and graphics device 3018. The embodiments, however, are not limited to these elements. Projection system 3021 can include a projector 3022 and a camera 3024.

As depicted, I/O device 3006, RAM 3008, and ROM 3010 are coupled to processor 3002 by way of chipset 3004. Chipset 3004 may be coupled to processor 3002 by a bus 3012. Accordingly, bus 3012 may include multiple lines.

Processor 3002 may be a central processing unit comprising one or more processor cores and may include any number of processors having any number of processor cores. The processor 3002 may include any type of processing unit, such as, for example, CPU, multi-processing unit, a reduced instruction set computer (RISC), a processor that have a pipeline, a complex instruction set computer (CISC), digital signal processor (DSP), and so forth. In some embodiments, processor 3002 may be multiple separate processors located on separate integrated circuit chips. In some embodiments processor 3002 may be a processor having integrated graphics, while in other embodiments processor 3002 may be a graphics core or cores.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other. Furthermore, aspects or elements from different embodiments may be combined.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

The disclosure can be implemented in any of a variety of embodiments. For example, the disclosure can be implemented in any embodiments from the following non-exhaustive list of example embodiments.

### Example 1

A projection system, comprising: a projector to project an image onto a surface; a camera to capture an image of an environment adjacent to the surface; logic, at least a portion of which is in hardware, the logic to: identify a user from the image; determine a gaze vector corresponding to the user; adjust at least one parameter of the image based on the gaze vector; send a control signal to the projector to include an indication to project the adjusted image onto the surface.

### Example 2

The projection system of example 1, the logic to: identify at least one facial feature of the user; and determine the gaze vector based on the at least one facial feature.

### Example 3

The projection system of example 2, wherein the at least one facial features includes an eye, a nose, an ear, a mouth, or a chin.

### Example 4

The projection system of example 2, the logic to: determine a direction between the at least one facial feature and a point on the projection surface; and determine the gaze vector based on the direction.

### Example 5

The projection system of example 4, wherein the direction includes three dimensional components.

### Example 6

The projection system of example 4, wherein the point on the projection surface is a center of the projection surface.

### Example 7

The projection system of example 4, wherein the point on the projection surface corresponds to an area of the projection surface onto which the adjusted image is to be projected.

### Example 8

The projection system of example 4, wherein the at least one parameter is a geometric parameter of the image.

### Example 9

The projection system of example 8, the logic to adjust at least one of a scale of the image or a proportion of the image.

### Example 10

The projection system of example 1, the user a first user and the gaze vector a first gaze vector, the logic to: identify a second user from the image; determine a second gaze vector corresponding to the second user: determine whether the first gaze vector and the second gaze vector are incident on the projection surface; and send a control signal to the projector to include an indication to project the image onto the surface.

### Example 11

The projection system of example 1, wherein the projector is a cathode ray tube projector, a liquid crystal display projector, a digital light processing projector, a liquid crystal on silicon projector, a light emitting diode projector, a laser diode projector, or a micro-electrical-mechanical system based projector.

### Example 12

The projection system of example 1, wherein the camera is a two-dimensional camera or a three-dimensional camera and wherein the camera includes at least one of a charge-coupled device image sensor or a complementary metal-oxide-semiconductor image sensor.

### Example 13

The projection system of example 1, comprising the projection surface.

### Example 14

The projection system of example 1, wherein the projection surface is table, a desktop, a wall, or a ceiling.

### Example 15

The projection system of example 1, the logic to: identify an appendage of the user from the image; determine a distance between the appendage and at least a portion of the project image; and send a control signal to the projector to include an indication to project content based on the distance.

### Example 16

A method comprising: capturing an image of a scene, the scene comprising an area adjacent to a projection surface; identifying a user from the image; determining a gaze vector corresponding to the user; adjusting at least one parameter of an image to be projected onto the projection surface based on the gaze vector; and sending a control signal to a projector to include an indication to project the adjusted image onto the projection surface.

### Example 17

The method of example 16, comprising: identifying at least one facial feature of the user; and determining the gaze vector based on the at least one facial feature.

### Example 18

The method of example 17, wherein the at least one facial features includes an eye, a nose, an ear, a mouth, or a chin.

### Example 19

The method of example 17, comprising: determining a direction between the at least one facial feature and a point on the projection surface; and determining the gaze vector based on the direction.

### Example 20

The method of example 19, wherein the direction includes three dimensional components.

### Example 21

The method of example 19, wherein the point on the projection surface is a center of the projection surface.

### Example 22

The method of example 19, wherein the point on the projection surface corresponds to an area of the projection surface onto which the adjusted image is to be projected.

### Example 23

The method of example 19, wherein the at least one parameter is a geometric parameter of the image.

### Example 24

The method of example 23, comprising adjusting at least one of a scale of the image or a proportion of the image.

### Example 25

The method of example 16, the user a first user and the gaze vector a first gaze vector, the method comprising: identifying a second user from the image; determining a second gaze vector corresponding to the second user: determining whether the first gaze vector and the second gaze vector are incident on the projection surface; and sending a control signal to the projector to include an indication to project the image onto the surface.

### Example 26

The method of example 16, comprising: identifying an appendage of the user from the image; determining a distance between the appendage and at least a portion of the project image; and sending a control signal to the projector to include an indication to project content based on the distance.

### Example 27

An apparatus comprising means for performing the method of any of examples 16 to 26.

### Example 28

At least one machine-readable storage medium comprising instructions that when executed by a computing device, cause the computing device to: capture an image of a scene, the scene comprising an area adjacent to a projection surface; identify a user from the image; determine a gaze vector corresponding to the user; adjust at least one parameter of an image to be projected onto the projection surface based on the gaze vector; and send a control signal to a projector to include an indication to project the adjusted image onto the projection surface.

### Example 29

The at least one machine-readable storage medium of example 28, comprising instructions that when executed by the computing device, cause the computing device to: identify at least one facial feature of the user; and determine the gaze vector based on the at least one facial feature.

### Example 30

The at least one machine-readable storage medium of example 29, wherein the at least one facial features includes an eye, a nose, an ear, a mouth, or a chin.

### Example 31

The at least one machine-readable storage medium of example 29, comprising instructions that when executed by the computing device, cause the computing device to: determining a direction between the at least one facial feature and a point on the projection surface; and determining the gaze vector based on the direction.

### Example 32

The at least one machine-readable storage medium of example 31, wherein the direction includes three dimensional components.

### Example 33

The at least one machine-readable storage medium of example 31, wherein the point on the projection surface is a center of the projection surface.

### Example 34

The at least one machine-readable storage medium of example 31, wherein the point on the projection surface corresponds to an area of the projection surface onto which the adjusted image is to be projected.

### Example 35

The at least one machine-readable storage medium of example 31, wherein the at least one parameter is a geometric parameter of the image.

### Example 36

The at least one machine-readable storage medium of example 35, comprising instructions that when executed by the computing device, cause the computing device to adjust at least one of a scale of the image or a proportion of the image.

### Example 37

The at least one machine-readable storage medium of example 28, the user a first user and the gaze vector a first gaze vector, the at least one machine-readable storage medium comprising instructions that when executed by the computing device, cause the computing device to: identify a second user from the image; determine a second gaze vector corresponding to the second user: determine whether the first gaze vector and the second gaze vector are incident on the projection surface; and send a control signal to the projector to include an indication to project the image onto the surface.

### Example 38

The at least one machine-readable storage medium of example 28, comprising instructions that when executed by the computing device, cause the computing device to: identify an appendage of the user from the image; determine a distance between the appendage and at least a portion of the project image; and send a control signal to the projector to include an indication to project content based on the distance.

1. A projection system, comprising:
a projector to project an image onto a surface;
a camera to capture an image of an environment adjacent to the surface;
logic, at least a portion of which is in hardware, the logic to:
identify a user from the image;
determine a gaze vector corresponding to the user;
adjust at least one parameter of the image based on the gaze vector to distort the image;
send a control signal to the projector to include an indication to project the adjusted image onto the surface such that the distorted image appears undistorted from the perspective of the gaze vector.

2. The projection system of claim 1, the logic to:
identify at least one facial feature of the user; and
determine the gaze vector based on the at least one facial feature.

3. The projection system of claim 2, wherein the at least one facial features includes an eye, a nose, an ear, a mouth, or a chin.

4. The projection system of claim 2, the logic to:
determine a direction between the at least one facial feature and a point on the surface; and
determine the gaze vector based on the direction.

5. The projection system of claim 4, wherein the direction includes three dimensional components.

6. The projection system of claim 4, wherein the point on the surface is a center of the surface.

7. The projection system of claim 4, wherein the point on the surface corresponds to an area of the surface onto which the adjusted image is to be projected.

8. The projection system of claim 4, wherein the at least one parameter is a geometric parameter of the image.

9. The projection system of claim 8, the logic to adjust at least one of a scale of the image or a proportion of the image.

10. The projection system of claim 1, the user a first user and the gaze vector a first gaze vector, the logic to:
identify a second user from the image;
determine a second gaze vector corresponding to the second user:
determine whether the first gaze vector and the second gaze vector are incident on the surface; and
send a control signal to the projector to include an indication to project the image onto the surface.

11. A method comprising:
capturing an image of a scene, the scene comprising an area adjacent to a projection surface;
identifying a user from the image;
determining a gaze vector corresponding to the user;
adjusting at least one parameter of an image to be projected onto the projection surface based on the gaze vector to distort the image; and
sending a control signal to a projector to include an indication to project the adjusted image onto the projection surface such that the distorted image appears undistorted from the perspective of the gaze vector.

12. The method of claim 11, comprising:
identifying at least one facial feature of the user; and
determining the gaze vector based on the at least one facial feature.

13. The method of claim 12, wherein the at least one facial features includes an eye, a nose, an ear, a mouth, or a chin.

14. The method of claim 12, comprising:
determining a direction between the at least one facial feature and a point on the projection surface; and
determining the gaze vector based on the direction.

15. The method of claim 14, wherein the direction includes three dimensional components.

16. The method of claim 14, wherein the point on the projection surface is a center of the projection surface.

17. The method of claim 14, wherein the point on the projection surface corresponds to an area of the projection surface onto which the adjusted image is to be projected.

18. The method of claim 14, wherein the at least one parameter is a geometric parameter of the image.

19. The method of claim 18, comprising adjusting at least one of a scale of the image or a proportion of the image.

20. The method of claim 11, the user a first user and the gaze vector a first gaze vector, the method comprising:
identifying a second user from the image;
determining a second gaze vector corresponding to the second user:
determining whether the first gaze vector and the second gaze vector are incident on the projection surface; and
sending a control signal to the projector to include an indication to project the image onto the surface.

21. At least one non-transitory machine-readable storage medium comprising instructions that when executed by a computing device, cause the computing device to:
capture an image of a scene, the scene comprising an area adjacent to a projection surface;
identify a user from the image;
determine a gaze vector corresponding to the user;
adjust at least one parameter of an image to be projected onto the projection surface based on the gaze vector to distort the image; and
send a control signal to a projector to include an indication to project the adjusted image onto the projection surface such that the distorted image appears undistorted from the perspective of the gaze vector.

22. The at least one non-transitory machine-readable storage medium of claim 21, comprising instructions that when executed by the computing device, cause the computing device to:
identify at least one facial feature of the user; and
determine the gaze vector based on the at least one facial feature.

23. The at least one non-transitory machine-readable storage medium of claim 22, comprising instructions that when executed by the computing device, cause the computing device to:
determining a direction between the at least one facial feature and a point on the projection surface; and
determining the gaze vector based on the direction.

24. The at least one non-transitory machine-readable storage medium of claim 23, wherein the direction includes three dimensional components.

25. The at least one non-transitory machine-readable storage medium of claim 21, the user a first user and the gaze vector a first gaze vector, the at least one machine-readable storage medium comprising instructions that when executed by the computing device, cause the computing device to:
identify a second user from the image;
determine a second gaze vector corresponding to the second user:
determine whether the first gaze vector and the second gaze vector are incident on the projection surface; and
send a control signal to the projector to include an indication to project the image onto the surface.
